(19) United States
(12) Patent Application Publication
(10) Pub. No.: US 2017/0139122 A1
(43) Pub. Date: May 18, 2017

(54) BACKLIGHT MODULE AND DISPLAY DEVICE

(71) Applicant: BOE TECHNOLOGY GROUP CO., LTD., Beijing (CN)

(72) Inventors: Shanshan ZHOU, Beijing (CN); Chengyu FU, Beijing (CN)

(73) Assignee: BOE TECHNOLOGY GROUP CO., LTD., Beijing (CN)

(21) Appl. No.: 15/302,993

(22) PCT Filed: Sep. 29, 2015
(86) PCT No.: PCT/CN2015/091020

§ 371 Date: Oct. 9, 2016

(30) Foreign Application Priority Data
May 28, 2015 (CN) 201510282813.9

(51) Int. Cl. F21V 8/00

(52) U.S. Cl. CPC G02B 6/0088; G02B 6/0091; G02B 6/0051; G02B 6/0053; G02B 6/0031; G02B 6/0021; G02B 6/0093

(57) ABSTRACT

The present disclosure provides a backlight module and a display device, in which backlight module, a frame, a backlight source and a protective film are provided. The frame is composed of a bottom plate and sidewalls disposed at the periphery of the bottom plate, the backlight source is accommodated within the space composed of the bottom plate and the sidewalls, wherein the light-emitting surface of the backlight source is away from the bottom plate. The protective film covers the light-emitting surface of the backlight source, extends along at least two opposite sidewalls of the frame to the outer side of the bottom plate away from the backlight source, and is fixedly connected to the outer side of the bottom plate away from the backlight source.

### CROSS-REFERENCE TO RELATED APPLICATIONS

The present application claims a priority of the Chinese patent application No. 201510282813.9 filed on May 28, 2015, which is incorporated herein by reference in its entirety.

### TECHNICAL FIELD

The present disclosure relates to the field of display technology, and in particular to a backlight module and a display device.

### BACKGROUND

With the increasing demand for nice appearance, people are more and more attracted by narrow-bezel display products.

The bezel range of a display product mainly depends on a backlight module carrying a display screen. In the prior art, the backlight module is mainly composed of a frame, a backlight source and a glue bezel, wherein the glue bezel is provided at the periphery of the frame, and the backlight source and other film material are fixed within the frame to achieve light shading.

Since the glue bezel has a certain thickness, the range of the display bezel is increased.

Although it is possible to decrease the range of the display bezel by reducing the thickness of the glue bezel, with an increasing concern about narrow-bezel display products, it is impossible to meet the narrow-bezel demand only by reducing the thickness of display product material.

### SUMMARY

The present disclosure provides a backlight module and a display device, which can implement a narrow-bezel display product.

The solution of the present disclosure is as follows.

The embodiment of the present disclosure provides a backlight module, including:

a frame, a backlight source and a protective film;

the frame includes a bottom plate and sidewalls at a periphery of the bottom plate, the backlight source is accommodated in a space formed by the bottom plate and the sidewalls of the frame, where a light-emitting surface of the backlight source is away from the bottom plate;

the protective film covers the light-emitting surface of the backlight source, extends along at least two opposite sidewalls of the frame to a side of the bottom plate away from the backlight source, and is fixed onto a surface of the bottom plate away from the backlight source.

Optionally, the protective film extends along two sidewalls of the frame in a length direction thereof to the side of the bottom plate away from the backlight source and is fixed to outside surfaces of the two sidewalls of the frame in the length direction thereof.

Optionally, the protective film extends along four sidewalls of the frame to the side of the bottom plate away from the backlight source and is fixed to outside surfaces of the four sidewalls of the frame.

Optionally, the frame is made of stainless steel, aluminum alloy or carbon fiber, and the protective film is made of a transparent material.

Optionally, a height of each of the sidewalls relative to the bottom plate is equal to a thickness of the backlight source.

Optionally, surfaces of the backlight source, excepting the light-emitting surface thereof, are in direct contact with the frame and covered by the frame.

Optionally, the backlight source includes:

a light guide plate in direct contact with the frame;

the light guide plate includes self-fixing portions, where the backlight source is fixed in the space formed by the bottom plate and the sidewalls of the frame via the self-fixing portions.

Optionally, the self-fixing portions are arranged at two sides of the light guide plate in a length direction of the light guide plate.

Optionally, each of the self-fixing portions is a protrusion, and the self-fixing portions are pressed against by the sidewalls of the frame, so as to fix the backlight source in the space.

Optionally, the light guide plate includes a light-emitting diode fixing portion configured to fix a light-emitting diode of the backlight source.

Optionally, the backlight source further includes:

a first reflecting film on a first surface of the light guide plate, where the first surface of the light guide plate is the surface of the light guide plate close to the bottom plate;

a diffusing film on a second surface of the light guide plate, where the second surface of the light guide plate is the surface of the light guide plate away from the bottom plate;

a first prism film at a side of the diffusing film away from the light guide plate; and

a second prism film at a side of the first prism film away from the diffusing film;

The protective film is arranged at a side of the second prism film away from the first prism film.

Optionally, the backlight source further includes:

a second reflecting film arranged at a side of the light-emitting diode away from the light guide plate and at a side of the light-emitting diode away from the first reflecting film.

Optionally, a portion of the protective film at a periphery of the backlight source is lightproof.

A display device is further provided by the present disclosure, including the backlight module hereinabove.

Optionally, the protective film of the backlight module wraps the frame and the backlight source of the backlight module, the display device further includes a display panel adhered onto a surface of the protective film away from the backlight source.

Optionally, the protective film is adhesive, and the display panel is directly adhered onto the protective film through the adhesive protection film.

Optionally, surfaces of the backlight source, excepting the light-emitting surface thereof, are in direct contact with the frame and covered by the frame.

Optionally, the backlight source includes a light guide plate in direct contact with the frame.

As can be seen from the above, a narrow-bezel display product may be implemented by the backlight module and the display device provided by the present disclosure, in which backlight module, a frame, a backlight source and a protective film are provided; wherein the frame is composed of a bottom plate and sidewalls disposed at the periphery of the bottom plate, the backlight source is accommodated within the space composed of the bottom plate and the sidewalls, wherein the light-emitting surface of the backlight source is away from the bottom plate; the protective film covers the light-emitting surface of the backlight source, extends along at least two opposite sidewalls of the frame to the outer side of the bottom plate away from the backlight source, and is fixedly connected to the outer side of the bottom plate away from the backlight source.

### BRIEF DESCRIPTION OF THE DRAWINGS

FIG. 1 is a schematic view of a backlight module in some embodiments of the present disclosure;

FIG. 2 is a schematic view of a backlight module in some embodiments of the present disclosure;

FIG. 3 is a schematic view of a light guide plate and a light-emitting diode of a backlight module in some embodiments of the present disclosure;

FIG. 4 is a schematic view of a backlight module in some embodiments of the present disclosure.

### DETAILED DESCRIPTION OF THE EMBODIMENTS

To make the purpose, technical solution and advantages of the embodiment of the present disclosure, the technical solution of the embodiment of the present disclosure will be clearly and completely described in conjunction with the accompanying drawings of the embodiment of the present disclosure. Obviously, the described embodiment is merely part of, instead of all of, the embodiments of the present disclosure. Based on the embodiment of the present disclosure described herein, all other embodiments obtained by those of ordinary skill are within the scope of the present disclosure sought for protection.

Unless otherwise defined, technical terms or scientific terms used herein shall have the common meaning understood by those of ordinary skill in the related art. “first”, “second” and similar words used in the description and claims of the present patent application do not represent any order, quantity, or importance, but are used to distinguish different components only. Similarly, the “a” or “one” and similar words do not represent quantity, but rather indicate the presence of at least one. “Connected” or “attached” and similar words do not define physical or mechanical connections, but may include electrical connections, regardless direct or indirect. “Up”, “down”, “left”, “right” and the like are only used to indicate the relative positional relationship, and when the absolute position of an object described is changed, the relative positional relationship is changed accordingly.

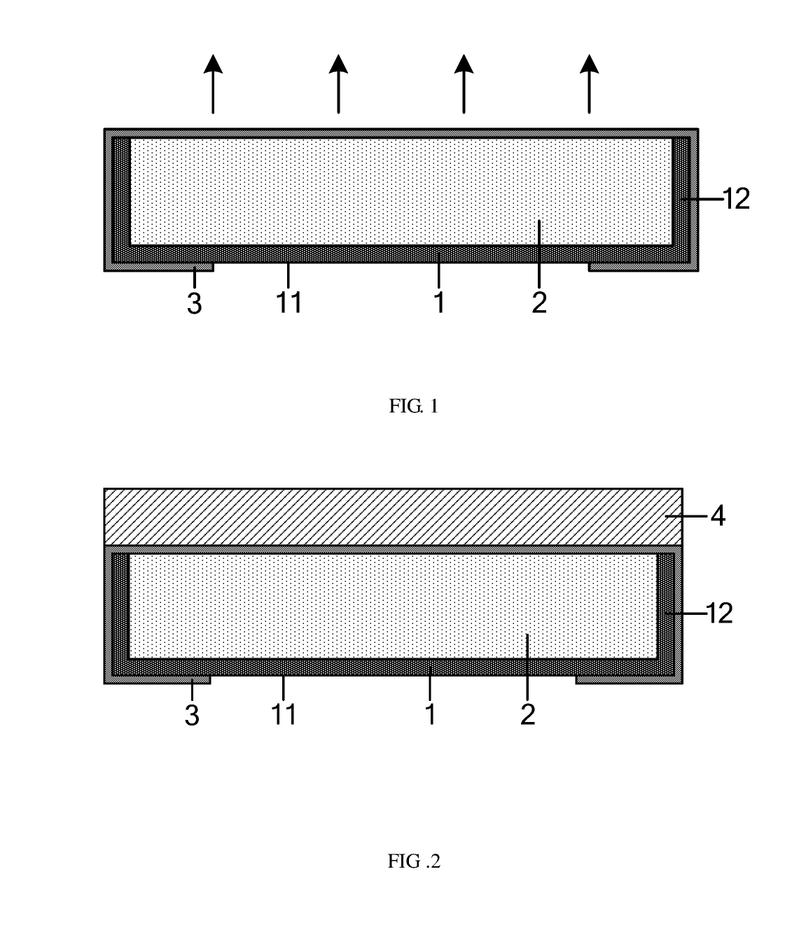

A backlight module is provided in some embodiments of the present disclosure. As shown in FIG. 1, the backlight module may include:

a frame 1, a backlight source 2 and a protective film 3.

The frame 1 includes a bottom plate 11 and sidewalls 12 at a periphery of the bottom plate 11. The backlight source 2 is accommodated in a space formed by the bottom plate 11 and the sidewalls 12 of the frame. A light-emitting surface of the backlight source 2 (a light-emitting direction represented by the arrow in FIG. 1) is away from the bottom plate 11.

The protective film 3 covers the light-emitting surface of the backlight source 2, extends along at least two opposite sidewalls 12 of the frame 1 to a side of the bottom plate 11 away from the backlight source 2, and is fixed onto a surface of the bottom plate 11 away from the backlight source 2.

According to the backlight module in the embodiment of the present disclosure, without the glue bezel in the related art, the backlight source 2 (including a light guide plate 21 and other film materials) is in direct contact with the frame 1, thereby reducing the size of the backlight module and narrowing the border frame of the display product.

In addition, the backlight module is provided with a protective film 3. The protective film 3 covers the backlight source 2 in the frame 1 in a wrapping way, in order to fix the backlight source 2, thereby avoiding the problem that the backlight source cannot be fixed due to the removal of the glue bezel in the related art.

The protective film 3 in the embodiment of the present disclosure may be a nonopaque material, so as to fix the backlight source 2 without influencing adversely the optical effect of the backlight source 2.

In order to fix the frame 1, the protective film 3 maybe adhesive. In addition, an adhesive material may be coated onto the surface of the protective film 3 in contact with the bottom plate 11 of the frame 1, so as to fix the protective film 3 to the outside surface of the bottom plate 11.

Specifically, the protective film 3 may extend along two sidewalls 12 of the frame 1 in a length direction thereof to the side of the bottom plate 11 away from the backlight source 2 and is fixed to the outside surface bottom plate 11, so as to fix the backlight source 2 without increasing the width of the backlight module.

Optionally, the protective film 3 is fixed to the outside surfaces of the two sidewalls 12 of the frame in the length direction thereof.

In some embodiments of the present disclosure, the protective film 3 may extend along four sidewalls 12 of the frame 1 to the side of the bottom plate 11 away from the backlight source 2 and is fixed to the outside surface of the bottom plate 11.

Optionally, the protective film 3 is further fixed to the outside surfaces of the four sidewalls 12 of the frame.

The material of the frame 1 in the embodiment of the present disclosure may be stainless steel, aluminum alloy and so on. In order to reduce the weight of the frame 1 and the backlight module, the frame 1 may be made of carbon fiber and other materials.

The bottom plate 11 in the embodiment of the present disclosure may be rectangular or the like. Taking a rectangle as an example, sidewalls 12 may be arranged at four side edges of the bottom plate 11, so as to form a space for accommodating the backlight source 2. In addition, in order to reduce the weight and width of the backlight module, sidewalls 12 may be arranged at merely two sides of the bottom plate 11 in the length direction thereof, so as to form a space accommodating the backlight source 2.

Specifically, a height of each of the sidewalls 12 relative to the bottom plate 11 may be equal to a thickness of the backlight source 2. As such, as shown in FIG. 2, when the protective film 3 wraps the backlight source 2, a display panel 4 may be adhered onto a surface of the protective film 3 away from the backlight source 2, without fixing the display panel 4 by using a frame at a periphery of the display panel 4. As such, the border frame of the display panel 4 is just the border frame of the backlight module, thereby narrowing the border frame of the display product.

In some embodiments of the present disclosure, the backlight source 21 may include a light guide plate 21.

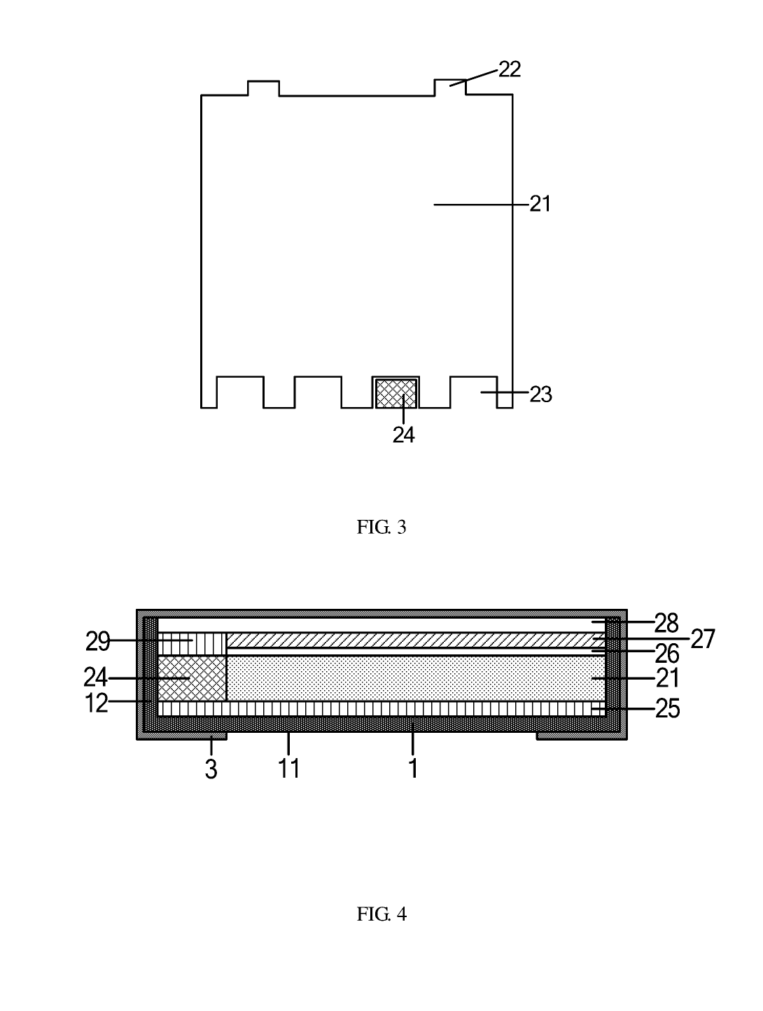

As shown in FIG. 3, the light guide plate 21 may be provided with a self-fixing portion 22 for fixing the backlight source 2 in the space composed of the bottom plate 11 and the sidewalls 12.

With the self-fixing portion 22 provided, it may be further guaranteed that the backlight source 2 is fixed within the frame 1.

In a specific embodiment, the self-fixing portion 22 may be arranged at two sides of the light guide plate 21 in a length direction thereof. The self-fixing portion 22 may be a protrusion, and the self-fixing portions 22 are pressed against by the sidewalls 12 of the frame 1, so as to fix the backlight source in the space formed by the bottom plate 11 and the sidewalls 12. There is not any fixing hole in the sidewalls 12 of the frame 1, so as to avoid a light leakage from the frame 1.

As shown in FIG. 3, the light guide plate 21 in the embodiment of the present disclosure may further include a light-emitting diode (LED) fixing portion 23 configured to fix a LED 24 in the backlight source 2.

The circuit wirings and other devices may be arranged in the LED fixing portion 23, so as to control the LED 24. The LED fixing portion 23 may be arranged at a predetermined position of the light guide plate 21 as needed, for example, one side of the light guide plate 21 in the length direction.

As shown in FIG. 4, the backlight source 2 in the embodiment of the present disclosure may further include the following film layers:

a first reflecting film 25 on a first surface of the light guide plate 21, where the first surface of the light guide plate is the surface of the light guide plate 21 close to the bottom plate 11 (i.e., the bottom side of the light guide plate 21 as shown in FIG. 4);

a diffusing film 26 on a second surface of the light guide plate 21, where the second surface of the light guide plate is the surface of the light guide plate 21 away from the bottom plate 11 (i.e., the upper side of the light guide plate 21 as shown in FIG. 4);

a first prism film 27 at a side of the diffusing film 26 away from the light guide plate 21; and

a second prism film 28 at a side of the first prism film 27 away from the diffusing film 26.

Since the second prism film 28 is arranged at the outmost side of the light-emitting surface of the backlight source 2, the protective film 3 may be arranged at the side of the second prism film 28 away from the first prism film 27 (i.e., the upper side of the second prism film 28 as shown in FIG. 4).

According to the embodiment of the present disclosure, in order to avoid light leakage at the position of the LED 24 in the backlight source 2, as shown in FIG. 4, the backlight module 2 may further include:

a second reflecting film 29 arranged at a side of the LED 24 away from the light guide plate 21 and at a side of the LED 24 away from the first reflecting film 25.

According to the embodiment of the present disclosure, in order to avoid light leakage at the side periphery of the backlight source 2, the portion of the protective film 3 corresponding to the side periphery of the backlight source 2 is lightproof, so as to avoid light leakage at the side periphery of the backlight source 2.

Then in a specific implementation, in or after the production process of the protective film 3, the protective film 3 may have a light-shading function through the corresponding processes on the portion of the protective film 3 corresponding to the side periphery of the backlight source 2.

The embodiment of the present disclosure also provides a display device, which display device may include the backlight module in the embodiment of the present disclosure.

The foregoing is merely the embodiment of the present disclosure. It should be noted that those of ordinary skill in the art may also further make a number of improvements and modifications, without departing from the principles of the present disclosure, which improvements and modifications also should be considered as the scope of the present disclosure sought for protection.

1. A backlight module, comprising:
a frame, a backlight source and a protective film;
wherein the frame comprises a bottom plate and sidewalls at a periphery of the bottom plate, the backlight source is accommodated in a space formed by the bottom plate and the sidewalls of the frame, wherein a light-emitting surface of the backlight source is away from the bottom plate;
the protective film covers the light-emitting surface of the backlight source, extends along at least two opposite sidewalls of the frame to a side of the bottom plate away from the backlight source, and is fixed onto a surface of the bottom plate away from the backlight source.

2. The backlight module according to claim 1, wherein the protective film extends along two sidewalls of the frame in a length direction thereof to the side of the bottom plate away from the backlight source and is fixed to outside surfaces of the two sidewalls of the frame in the length direction thereof.

3. The backlight module according to claim 1, wherein the protective film extends along four sidewalls of the frame to the side of the bottom plate away from the backlight source and is fixed to outside surfaces of the four sidewalls of the frame.

4. The backlight module according to claim 1, wherein the frame is made of stainless steel, aluminum alloy or carbon fiber, and the protective film is made of a transparent material.

5. The backlight module according to claim 1, wherein a height of each of the sidewalls relative to the bottom plate is equal to a thickness of the backlight source.

6. The backlight module according to claim 1, wherein surfaces of the backlight source, excepting the light-emitting surface thereof, are in direct contact with the frame and covered by the frame.

7. The backlight module according to claim 1, wherein the backlight source comprises:
a light guide plate in direct contact with the frame;
the light guide plate comprises self-fixing portions, wherein the backlight source is fixed in the space formed by the bottom plate and the sidewalls of the frame via the self-fixing portions.

8. The backlight module according to claim 7, wherein the self-fixing portions are arranged at two sides of the light guide plate in a length direction of the light guide plate.

9. The backlight module according to claim 7, wherein each of the self-fixing portions is a protrusion, and the self-fixing portions are pressed against by the sidewalls of the frame, so as to fix the backlight source in the space.

10. The backlight module according to claim 7, wherein the light guide plate comprises a light-emitting diode fixing portion configured to fix a light-emitting diode of the backlight source.

11. The backlight module according to claim 7, wherein the backlight source further comprises:
a first reflecting film on a first surface of the light guide plate, wherein the first surface of the light guide plate is the surface of the light guide plate close to the bottom plate;
a diffusing film on a second surface of the light guide plate, wherein the second surface of the light guide plate is the surface of the light guide plate away from the bottom plate;
a first prism film at a side of the diffusing film away from the light guide plate; and
a second prism film at a side of the first prism film away from the diffusing film;
wherein the protective film is arranged at a side of the second prism film away from the first prism film.

12. The backlight module according to claim 10, wherein the backlight source further comprises:
a second reflecting film arranged at a side of the light-emitting diode away from the light guide plate and at a side of the light-emitting diode away from the first reflecting film.

13. The backlight module according to claim 1, wherein a portion of the protective film at a periphery of the backlight source is lightproof.

14. A display device, comprising the backlight module according to claim 1.

15. The display device according to claim 14, wherein the protective film of the backlight module wraps the frame and the backlight source of the backlight module;
the display device further comprises a display panel adhered onto a surface of the protective film away from the backlight source.

16. The display device according to claim 15, wherein the protective film is adhesive, and the display panel is directly adhered onto the protective film through the adhesive protection film.

17. The display device according to claim 15, wherein surfaces of the backlight source, excepting the light-emitting surface thereof, are in direct contact with the frame and covered by the frame.

18. The display device according to claim 15, wherein the backlight source comprises a light guide plate in direct contact with the frame.

19. The backlight module according to claim 8, wherein each of the self-fixing portions is a protrusion, and the self-fixing portions are pressed against by the sidewalls of the frame, so as to fix the backlight source in the space.

20. The backlight module according to claim 12, wherein a portion of the protective film at a periphery of the backlight source is lightproof.
